(19) United States
(12) Patent Application Publication
(10) Pub. No.: US 2023/0156047 A1
(43) Pub. Date: May 18, 2023

(54) PEER TO PEER SOCKET BASE SYSTEM FOR MULTI USER AUDIO AND VIDEO CALL FRAME.

(71) Applicants: SALAH M. WERFELLI, Morgan Hill, CA (US); TANWIR ZAFAR SYEDMOHAMMAD, Tracy, CA (US)

(72) Inventors: SALAH M. WERFELLI, Morgan Hill, CA (US); TANWIR ZAFAR SYEDMOHAMMAD, Tracy, CA (US)

(21) Appl. No.: 17/525,563

(22) Filed: Nov. 12, 2021

(51) Int. Cl. H04L 29/06; H04M 7/00; H04W 8/00; H04W 76/14

(52) U.S. Cl. CPC H04L 65/1069; H04M 7/006; H04W 8/005; H04W 76/14

(57) ABSTRACT

The present invention relates to a peer to peer socket base system. The present invention particularly relates to the aforesaid peer-to-peer socket base system for multiuser audio and video VoIP call frame. The present invention addresses the bad server end and the same time high quality and reliable services for the users. The present invention is related to delivering cost efficient and reliable VoIP calls on various platforms and environments

### CROSS REFERENCE OF RELATED APPLICATION(S)

This application claims the benefit of U.S. Provisional Application No. 63/113,011, filed Nov. 12, 2020; each of the foregoing applications is incorporated by reference herein in its entirety.

### FIELD OF THE INVENTION

The present invention relates to a peer to peer socket base system. The present invention particularly relates to the aforesaid peer-to-peer socket base system for multiuser audio and video VoIP call frame. The present invention addresses the bad server end and the same time high quality and reliable services for the users. The present invention is related to delivering cost efficient and reliable VoIP calls on various platforms and environments

### BACKGROUND OF THE INVENTION

Wireless communication networks are widely deployed to provide various communication services such as voice, video, packet data, etc. These wireless networks include wireless wide area networks (WWANs) that provide communication coverage for large geographic areas, wireless local area networks (WLANs) that provide communication coverage for medium geographic areas, and wireless personal area networks (WPANs) that provide communication coverage for small geographic areas. Different wireless networks typically have different capabilities, requirements, and coverage areas.

A wireless device (e.g., a cellular phone) may be capable of communicating with one or more wireless networks, e.g., a WWAN and/or a WLAN. The wireless device may also be capable of communicating peer-to-peer with other wireless devices. The wireless device may be invoked by a user to make a call to another wireless device. The wireless device may be located within the coverage of zero, one or multiple wireless networks at the time the call is placed. From the user's perspective, it is desirable for the call to be connected as quickly and efficiently as possible, regardless of whether the wireless device is under the coverage of any wireless network.

There is therefore a need in the art for techniques to efficiently support communication for a wireless device.

### BRIEF DESCRIPTION OF DRAWINGS

FIG. 1 shows a deployment of a MAN and a WLAN.

### DETAILED DESCRIPTION OF THE INVENTION

Techniques for supporting peer-to-peer (PTP) communication between wireless devices are described herein. The techniques support communication even when WWAN and WLAN are not present. For a peer-to-peer call, a wireless device performs discovery of a target wireless device, performs authentication of the target wireless device and generates a session key, e.g., using a pre-shared key or a certificate provisioned on the wireless device, forms an ad hoc wireless network with the target wireless device, and communicates peer-to-peer with the target wireless device via the ad hoc wireless network. Each of the phases may be performed in various manners. This aspect may also be implemented via a method, apparatus or computer program product.

In an aspect, a wireless device performs discovery with a list of identifiers. The wireless device receives a frame (e.g., a beacon frame or a probe request) from another wireless device, extracts an identifier from the received frame, determines whether the extracted identifier is included in the list of identifiers, and sends a response if the extracted identifier is included in the list. An identifier may be derived based on one or more phone numbers and/or other identification information for one or more wireless devices. The list may include identifiers for other wireless devices designated to communicate peer-to-peer with this wireless device. This aspect may also be implemented via a method, apparatus or computer program product.

In another aspect, a wireless device performs background or active discovery to discover other wireless devices. For background discovery, the wireless device may periodically send and receive frames for discovery of other wireless devices. Each frame may include an identifier for the sending wireless device. For active discovery, the wireless device may periodically receive frames and may send frames only to discover a target wireless device (e.g., at the start of a call). Each transmitted frame may include an identifier for the target wireless device. For both background and active discoveries, the wireless device may send and/or receive frames during pseudo-randomly selected time intervals or fixed time intervals determined based on timing obtained from a wireless communication network, e.g., a cellular network. This aspect may also be implemented via a method, apparatus or computer program product.

In yet another aspect, a service set identifier (SSID) used to identify an ad hoc wireless network is derived based on one or more user-specific identifiers for one or more wireless devices, e.g., a phone number for a calling wireless device and/or a phone number for a called wireless device in a peer-to-peer call. The SSID may be used as an identifier that is included in each frame sent for discovery. This aspect may also be implemented via a method, apparatus or computer program product.

In yet another aspect, a wireless device performs Internet Protocol (IP) address discovery for a peer-to-peer call. The wireless device forms a packet containing a user-specific identifier (e.g., a phone number) for a target wireless device, sends the packet to request for an IP address of the target wireless device, receives a response including the IP address of the target wireless device, and communicates peer-to-peer with the target wireless device using the IP address. This aspect may also be implemented via a method, apparatus or computer program product.

In yet another aspect, the wireless device handles traffic data for a peer-to-peer call to achieve the desired performance. The wireless device ascertains quality of service (QoS) requirements for a peer-to-peer call with a target wireless device, processes traffic data for the peer-to-peer call in accordance with the QoS requirements, and sends the processed traffic data to the target wireless device. This aspect may also be implemented via a method, apparatus or computer program product.

In a further aspect, a wireless communication device is configured to obtain authorization for communication via a wireless network from a wireless client device of the wireless network and to communicate via the wireless network after obtaining authorization from the wireless client device. This aspect may also be implemented via a method, apparatus or computer program product.

Various aspects and features of the disclosure are described in further detail below.

Call Frame designed and mentioned in this document is to facilitate a high-quality multi-platform/multiuser VoIP call by establishing a peer-to-peer socket base connection between all the participants of the call. The Call frame will support Desktop Web-based Environment, Desktop Apps, and Apps on Mobile Devices. Currently there are several solutions available in the market, but this solution is unique in the sense that when a connection is established between all the participants of the call, it removes the server in between that is used for connecting all the participants and thus load that might be put on the backend server. Moreover, during a group call, if connection is dropped by one of the participants, then other connections remain active and the dropped participant can rejoin the call.

In this document we will explain the architecture that we have made to accomplish the VoIP calls.

### Technologies Used:

1. Real Time Communication media server
2. Tools to Establish the Call
3. Signaling Server (Socket.io/Node.js)
4. Notification Responder
5. Mobile and Web application development platform

### Real Time Communication Media Server:

We have used the Real Time Communication media server to make the connections between the clients.

### Tools to Establish the Call:

CallKit is the framework provided by apple to handle the incoming and outgoing calls on iOS operating system

Signaling Server (Socket.io/Node.js):

socket.io is the messaging framework used to communicate between the clients that provides a way to send and receive events, based on these events the calling functionality is achieved

### Notification Responder:

PushKit is the framework provided by the apple which shows very high priority call interface for both the caller and callee

### Mobile and Web Application Development Platform:

Firebase is the framework provided by Google that gives us the functionality for sending and receiving push notifications for incoming calls

### Steps:

1. First of all when a user presses the call button the socket connection has to be connected so that we can send and receive the events that are required to establish a channel by which we will send and receive multiple events and then if the callee is online then the “NewCall” event has to be sent to the callee and the signaling server receives this event and then send it to the user to which the call has to be made and if the callee is not online then signaling server sends push notification to the callee by using Notification Responder and Mobile and Web application development platform.
2. Once the callee receives the “NewCall” event request, he/she has to send the NewCallReceived event and also peer factory will be started, and peer connection will also be initialized and inserted into global array.
3. When the caller receives the NewCallReceived notification event, ringing will be shown and a new box will be added on the screen indicating that the connection is being initiated and handshake is in progress.
4. When the callee receives the NewCall event the call screen will be shown on his side and along with the accept and reject buttons, if the callee receives the push notification for the call then the default interface for the incoming call is shown to the user and if the person receives the call on socket then the incoming screen for the call is shown both in the app and also with in the Tools to establish the Call. On the screen the name of the caller will be displayed and if it is a group then the name of the group will be displayed.
5. After the call has been received by the callee he/she must either accept or reject the call and if the callee rejects the call then the “reject” event will be sent to the caller and the call screen will be finished on both sides. If the callee accepts the call then the ReadyForCall event notification is sent to the caller.
6. When the ReadyForCall event is sent to the caller a new peer connection will be made on both the sides and on the caller side ringing will be shown and a new box will be added on the screen indicating that the connection is being initiated and handshake is in progress.
7. If the callee rejects the incoming call then the reject event will be sent to the caller.
8. When the reject event notification is received by the caller, the call screen is finished and call is terminated.
9. If the callee accepts the call then the answer is sent to the caller
10. When the answer is received by the caller, the ice candidates are sent to the callee.
11. When the ice candidates are received on both the sides, then the audio and video engine on both sides are initialized and from one of the candidates a stable connection is established and video and audio streams are shared among the caller and callee.
12. At this point on both the sides audio sessions are initialized and control is given in the app to either initialize manual audio engine or pre-defined audio engine.

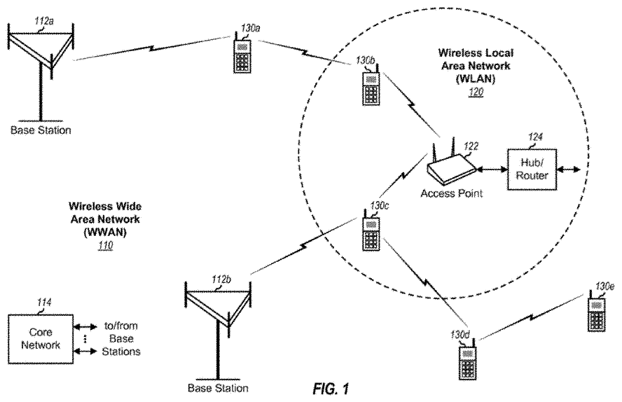

FIG. 1 shows a deployment of a WWAN 110 and a WLAN 120. WWAN 110 provides communication coverage for a large geographic area such as, e.g., a city, a state, or an entire country. WWAN 110 may be a cellular network such as a Code Division Multiple Access (CDMA) network, a Time Division Multiple Access (TDMA) network, a Frequency Division Multiple Access (FDMA) network, an Orthogonal FDMA (OFDMA) network, etc. A CDMA network may utilize a radio technology such cdma2000, Wideband-CDMA (W-CDMA), etc. cdma2000 covers IS-95, IS-2000, and IS-856 standards. A TDMA network may utilize a radio technology such as Global System for Mobile Communications (GSM). These various radio technologies, standards, and cellular networks are known in the art. WWAN 110 may also be a broadcast network such as a MediaFLO network, a Digital Video Broadcasting for Handhelds (DVB-H) network, an Integrated Services Digital Broadcasting for Terrestrial Television Broadcasting (ISDB-T) network, etc. These broadcast networks are also known in the art.

In following description, WWAN 110 is a cellular network that includes base stations that support communication for wireless devices within the coverage area of the WWAN. For simplicity, only two base stations 112 a and 112 b are shown in FIG. 1. A base station is a station that communicates with the wireless devices. A base station may also be called, and may contain some or all of the functionality of, a Node B, a base transceiver station (BTS), an access point, etc. A core network 114 couples to the base stations and provides coordination and control for the base stations. Core network 114 may also couple to other networks, e.g., a public switched telephone network (PSTN), a wide area network (WAN) such as the Internet, etc.

WLAN 120 provides communication coverage for a medium geographic area such as a mall, an airport terminal, a building, etc. WLAN 120 may include any number of access points that support communication for any number of stations. For simplicity, only one access point 122 is shown in FIG. 1. WLAN 120 may implement the IEEE 802.11 family of standards, some other WLAN standard, or some other WLAN radio technology. The IEEE 802.11 family of standards covers 802.11, 802.11b, 802.11g and 802.11n, which specify different radio technologies. As used herein, Wi-Fi refers to IEEE 802.11 as well as other WLAN standards and radio technologies. Access point 122 may couple to a hub/router 124 that may support communication with a local area network (LAN) and/or a WAN. Access point 122 and hub/router 124 may also be combined into a single wireless router.

Wireless devices 130 may be dispersed throughout the coverage areas of WWAN 110 and WLAN 120 as well as outside the coverage of these wireless networks. For simplicity, only five wireless devices 130 a through 130 e are shown in FIG. 1. A wireless device may be stationary or mobile. A wireless device may also be called, and may contain some or all of the functionality of, a mobile station, a user equipment, a station, a terminal, an access terminal, a subscriber unit, etc. A wireless device may be a cellular phone, a handheld device, a personal digital assistant (PDA), a laptop computer, a wireless modem, a handset, etc.

A wireless device may be capable of communicating with any number of wireless networks of any radio technologies. For example, a wireless device may be capable of communicating with WWAN 110 and/or WLAN 120. A wireless device may thus be a WWAN device as well as a WLAN station, e.g., a cellular phone with Wi-Fi capabilities.

A wireless device may be able to communicate with zero, one, or multiple wireless networks at any moment depending on (a) the capabilities of the wireless device and (b) the location of the wireless device, e.g., whether it is located within the coverage of any wireless network. In the example shown in FIG. 1, wireless device 130 a can communicate with WWAN 110, wireless device 130 b can communicate with WLAN 120, wireless device 130 c can communicate with both WWAN 110 and WLAN 120, and wireless devices 130 d and 130 e are outside of the coverage of WWAN 110 and WLAN 120.

Wireless devices with Wi-Fi capabilities may be able to communicate directly with each other via ad hoc wireless networks. An ad hoc wireless network is a wireless network that may be formed on the fly as needed, typically without a central controlling entity such as an access point, and may be dissolved when no longer needed. An ad hoc wireless network may be formed by, and may include, wireless devices desiring to communicate peer-to-peer with one another.

Peer-to-peer (PTP) and push-to-talk (PTT) features may be supported in wireless devices using Wi-Fi capabilities. PTT typically involves maintaining a connection so that communication can quickly commence when initiated by a user. The PTP and PTT features may be desirable in various scenarios. For example, a family may visit a mall, and each family member may go to a different store. The family members may be able to keep in touch by calling one other directly using Wi-Fi. As another example, a group may go on a hike where WWAN coverage is not available. The group members may be able to communicate with one another using WiFi.

The techniques described herein may be used for various types of call between Wi-Fi enabled wireless devices. For example, the techniques may be used for Voice-over-Internet Protocol (VoIP) calls, data calls, video calls, Short Message Service (SMS) messaging, etc.

A peer-to-peer call between two wireless devices includes the following phases:
1. Discovery-discover the presence of other wireless device(s) via Wi-Fi,
2. Session security-establish a session key for use during the call,
3. Call establishment-exchange signaling to set up the call,
4. Data exchange-schedule and handle traffic data to achieve the desired QoS, and
5. Call release-exchange signaling to release the call.
Additional phases such as IP address discovery may be present for some calls.

A peer-to-peer call may be established under one of the following scenarios:
1. WWAN and WLAN are both not present,
2. WWAN is present but WLAN is not present,
3. WWAN is not present but WLAN is present, and
4. WWAN and WLAN are both present.

Some of the phases may be performed in different manners depending on whether WWAN and/or WLAN are present, as described below.

### Discovery

Discovery may be performed in various manners—with and without WLAN and with and without WWAN. To facilitate discovery, e.g., when WLAN and WWAN are not present, a wireless device may be provisioned with a list of identifiers for other wireless devices that can communicate peer-to-peer with this wireless device. This list may be referred to as a PTP list, a “buddy” list, etc. The provisioning of the PTP list may be done by a service provider, a user, and/or some other entity. For example, the wireless device may have a phone book of numbers for convenient dialing, and all wireless numbers or just certain wireless numbers in the phone book may be included in the PTP list. The PTP list may be provisioned on the wireless device and may include all phone numbers that the user expects to communication with via peer-to-peer.

In one design, which is referred to as background discovery, a wireless device periodically sends and receives frames for discovery of other wireless devices. Each wireless device periodically sends beacon frames, with each beacon frame containing an identifier for the sending wireless device. A beacon frame is a management frame that conveys certain information regarding the sending wireless device. In general, an identifier may be an SSID, a phone number, a hash of the phone number, or some other identification information. Other wireless devices in the vicinity of the sending wireless device receive the beacon frames. Each receiving wireless device extracts the identifier from each received beacon frame and compares the extracted identifier against the identifiers in its PTP list. If the extracted identifier is included in the PTP list, then the receiving wireless device sends a response back to the sending wireless device. After discovery, the sending and receiving wireless devices may engage in the next phase, e.g., authentication, if a call is initiated between the two wireless devices. The PTP list may be used to filter unwanted frames and to respond to frames from only wireless devices of interest.

A wireless device may operate in a power save mode to conserve battery power. In the power save mode, the wireless device may power up periodically for a short period of time to send and/or receive frames and may power down in the time between the awake periods. The wireless device may thus operate in accordance with a sleep-awake cycle, which is one cycle of an awake period and a sleep period.

The wireless devices are generally not synchronized in time and, while in the power save mode, their sleep-awake cycles are likely to be different.

Hence, even though the wireless devices may be close by, one wireless device may be asleep when another wireless device is sending a frame, and vice versa. To combat unsynchronized timing, the wireless devices may wake up randomly to send and/or receive frames. A wireless device may use a random number generator to select when to wake up next, then go to sleep, and then wake up at the expiry of the randomly selected time. The amount of time for two wireless devices to discover one another may then be dependent on the awake duration and the sleep-awake cycle. For example, if each wireless device is awake for a 10 millisecond (ms) period within a sleep-awake cycle of 100 ms, then the two wireless devices will discover each other with high probability after seconds.

A wireless device may turn off its radio frequency (RF) and physical layer (PHY) sections during sleep time, and only a processor may be awake. The processor may use a timer to trigger power up of the RF and PHY sections, to send frames, and to scan the wireless medium for frames from other wireless devices. The wireless device may be awake, e.g., for 10 ms in a sleep-awake cycle of 100 ms. All wireless devices may have the same sleep-awake cycle but may not be synchronized. The 100 ms sleep-awake cycle may be partitioned into ten slots, with each slot having a duration of 10 ms. The wireless device knows its sleep-awake cycle duration and keeps track of the ten slots in the sleep-awake cycle. In a given sleep-awake cycle, the processor may select a random number between 0 and 9 and may turn on the RF and PHY sections in the selected slot to listen for frames from other wireless devices. If no frames are received during the selected slot, the processor may turn off the RF and PHY sections. In the next sleep-awake cycle, the processor may again select a random number and may repeat the process. If another wireless device in the vicinity is doing the same transmit and receive processing, then there is over 99% chance that the two wireless devices will discover each other in five seconds. The discovery time may be greater or less depending on the duty cycle, which is the ratio of the awake duration to the sleep-awake cycle duration. However, this processing is background activity and power, is mainly consumed during the awake time of the sleep-awake cycle.

In another design, which is referred to as active discovery, a wireless device periodically receives frames from other wireless devices but sends frames only to discover a target wireless device, e.g., when a call is made. When a user places the call, the calling wireless device enters a discovery mode and broadcasts a probe request containing an identifier for a called wireless device. The calling wireless device then waits for a probe response from the called wireless device and, if none is received within a predetermined amount of time, sends another probe request. The calling wireless device may also continuously send probe requests through at least one sleep-awake cycle because the called wireless device may be in the power save mode. The calling wireless device may send probe requests through a sufficient number of sleep-awake cycles of the called wireless device in order to ensure that the called wireless device is given sufficient opportunity to receive a probe request. To cover the case in which the called wireless device is operating on a different frequency channel, the calling wireless device may send probe requests for at least one sleep-awake cycle on one frequency channel and, if a probe response is not received, switch to another frequency channel and continue to send probe requests. When the called wireless device receives a probe request and determines that the probe request is addressed to it, the called wireless device sends a probe response to the calling wireless device.

With active discovery, a wireless device sends probe requests only when needed, e.g., when a call is made. All wireless devices are in a passive listen mode whenever they are awake. To combat unsynchronized timing, a calling wireless device may send probe requests at randomly selected time intervals. Each wireless device may listen for probe requests in randomly selected time intervals.

Active and background discoveries may be enhanced by the presence of WWAN and/or WLAN. The wireless devices may be able to obtain timing from the WWAN or WLAN and may use the timing to achieve time synchronization. The wireless devices may schedule their beacon frames and/or probe requests based on the timing from the WWAN or WLAN. For example, when a call is placed, the calling wireless device may send a probe request at a predetermined time. Other wireless devices are awake at that time because of the synchronization provided by the WWAN or WLAN timing and can efficiently receive the probe request from the calling wireless device.

Discovery may also be performed with assistance from the WWAN and/or WLAN, if present. For example, the calling wireless device may communicate with the WWAN or WLAN and may request the WWAN or WLAN to page the called wireless device. The called wireless device may respond to the WWAN or WLAN or directly to the calling wireless device.

A wireless device may turn off its radio frequency (RF) and physical layer (PHY) sections during sleep time, and only a processor may be awake. The processor may use a timer to trigger power up of the RF and PHY sections, to send frames, and to scan the wireless medium for frames from other wireless devices. The wireless device may be awake, e.g., for 10 ms in a sleep-awake cycle of 100 ms. All wireless devices may have the same sleep-awake cycle but may not be synchronized. The 100 ms sleep-awake cycle may be partitioned into ten slots, with each slot having a duration of 10 ms. The wireless device knows its sleep-awake cycle duration and keeps track of the ten slots in the sleep-awake cycle. In a given sleep-awake cycle, the processor may select a random number between 0 and 9 and may turn on the RF and PHY sections in the selected slot to listen for frames from other wireless devices. If no frames are received during the selected slot, the processor may turn off the RF and PHY sections. In the next sleep-awake cycle, the processor may again select a random number and may repeat the process. If another wireless device in the vicinity is doing the same transmit and receive processing, then there is over 99% chance that the two wireless devices will discover each other in five seconds. The discovery time may be greater or less depending on the duty cycle, which is the ratio of the awake duration to the sleep-awake cycle duration. However, this processing is background activity and power, is mainly consumed during the awake time of the sleep-awake cycle.

In another design, which is referred to as active discovery, a wireless device periodically receives frames from other wireless devices but sends frames only to discover a target wireless device, e.g., when a call is made. When a user places the call, the calling wireless device enters a discovery mode and broadcasts a probe request containing an identifier for a called wireless device. The calling wireless device then waits for a probe response from the called wireless device and, if none is received within a predetermined amount of time, sends another probe request. The calling wireless device may also continuously send probe requests through at least one sleep-awake cycle because the called wireless device may be in the power save mode. The calling wireless device may send probe requests through a sufficient number of sleep-awake cycles of the called wireless device in order to ensure that the called wireless device is given sufficient opportunity to receive a probe request. To cover the case in which the called wireless device is operating on a different frequency channel, the calling wireless device may send probe requests for at least one sleep-awake cycle on one frequency channel and, if a probe response is not received, switch to another frequency channel and continue to send probe requests. When the called wireless device receives a probe request and determines that the probe request is addressed to it, the called wireless device sends a probe response to the calling wireless device.

With active discovery, a wireless device sends probe requests only when needed, e.g., when a call is made. All wireless devices are in a passive listen mode whenever they are awake. To combat unsynchronized timing, a calling wireless device may send probe requests at randomly selected time intervals. Each wireless device may listen for probe requests in randomly selected time intervals.

The techniques described herein may be implemented by various means. For example, the techniques may be implemented in hardware, firmware, software, or a combination thereof. For a hardware implementation, the processing units at a wireless device may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

Headings are included herein for reference and to aid in locating certain sections. These headings are not intended to limit the scope of the concepts described therein under, and these concepts may have applicability in other sections throughout the entire specification.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A peer to peer socket base system for multiuser audio and video call frame comprising:
discovering the presence of other wireless device(s) via WiFi;
establishing a session key for use during the call;
exchanging signaling to set up the call;
scheduling and handling traffic data to achieve the desired QoS; and
exchanging signaling to release the call;
wherein, additional phases such as IP address discovery may be present for some calls.

2. The peer to peer socket base system as claimed in claim 1 wherein, the discovery is performed in various manner including with and without WLAN and with and without WWAN.

3. The peer to peer socket base system as claimed in claim 1 wherein, the discovery is facilitated when WLAN and WWAN are not present, a wireless device may be provisioned with a list of identifiers for other wireless devices that can communicate peer-to-peer with this wireless device.

4. The peer to peer socket base system as claimed in claim 1 wherein, the provisioning of the PTP list may be done by a service provider, a user, and/or some other entity.

5. The peer to peer socket base system as claimed in claim 1 wherein, the peer to peer list may be provisioned on the wireless device and may include all phone numbers that the user expects to communication with via peer-to-peer.
